(19) United States
(12) Patent Application Publication
(10) Pub. No.: US 2024/0214886 A1
(43) Pub. Date: Jun. 27, 2024

(54) METHOD, APPARATUS AND COMPUTER PROGRAM

(71) Applicant: Nokia Technologies Oy, Espoo (FI)

(72) Inventors: Ömer BULAKCI, Munich (DE); Philippe GODIN, Massy (FR); Rajesh Babu NATARAJAN, Bangalore (IN); Alessio CASATI, West Molesey, Surrey (GB); Srinivas BANDI, Bangalore, Karnataka (IN)

(21) Appl. No.: 18/577,120

(22) PCT Filed: Jun. 23, 2022
(86) PCT No.: PCT/EP2022/067135

§ 371 Date: Jan. 5, 2024

(30) Foreign Application Priority Data
Jul. 8, 2021 (IN) 202141030695

(51) Int. Cl. H04W 36/00; H04W 48/20; H04W 68/02; H04W 76/20

(52) U.S. Cl. CPC H04W 36/00835; H04W 48/20; H04W 68/02; H04W 76/20

(57) ABSTRACT

There is provided an apparatus in a first network access node, the apparatus comprising means configured to perform: obtaining cell information comprising a list of network slices supported by at least one neighbour cell neighbouring a serving cell, wherein the network slices in the list are non-uniformly supported in a tracking area associated with the at least one neighbour cell. The means further configured to perform: identifying, using the obtained cell information, a target cell from the at least one neighbour cell that supports a network slice currently used by a user equipment, for performing a change from the serving cell to the target cell.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus for a first network access node, the apparatus comprising means configured to perform: obtaining cell information comprising a list of network slices supported by at least one neighbour cell neighbouring a serving cell, wherein the network slices in the list are non-uniformly supported in a tracking area associated with the at least one neighbour cell; and identifying, using the obtained cell information, a target cell from the at least one neighbour cell that supports a network slice currently used by a user equipment, for performing a change from the serving cell to the target cell.

In an example, the cell information is obtained from a network management function of the first network access node.

In an example, the means are configured to perform: receiving, from a second network access node serving the at least one neighbour cell, the cell information in a first message.

In an example, the means are configured to perform: providing, to the second network access node, a request message identifying the target cell for a handover of the user equipment.

In an example, the change from the serving cell to the target cell is performed by triggering a redirection procedure towards the user equipment.

In an example, the RRC redirection is triggered by the first network access node, in response to the UE initiating a registration procedure and the first network access node learning about the allowed network slices for the UE from an AMF through an initial context setup request.

In an example, the redirection procedure in an RRC redirection procedure.

In an example, the redirection is performed toward a frequency that is associated with the target cell.

In an example, the means are configured to perform: in response to determining that the at least one neighbour cell belonging to a second network access node does not support the network slice, refraining from providing the handover request message to the second network access node.

In an example, the network slice being used by the user equipment is non-uniformly supported in a tracking area associated with the serving cell.

In an example, the first network access node serves the user equipment. In an example, the first network access node provides the serving cell.

In an example, the network slice is being used in a protocol data unit session between the first network access node and the user equipment.

In an example, the first message comprises an indication of the tracking area that the at least one cell is comprised in.

In an example, the means are configured to perform: receiving, from a third network access node serving at least one further neighbour cell, further cell information in a second message, wherein the further cell information comprises a list of network slices that are non-uniformly supported by the at least one further neighbour cell.

In an example, the means configured to perform the determining is further configured to perform: determining, using the cell information and further cell information, whether the at least one neighbour cell and/or the at least one further neighbour cell supports the network slice.

In an example, the cell information and further cell information is provided by a single network access node.

In an example, the means are configured to perform: in response to determining that both the least one neighbour cell and the at least one further neighbour cell support the network slice, providing the request message comprising an indication that both the least one neighbour cell and the at least one further neighbour cell are candidates for the handover of the user equipment.

In an example, the means are configured to perform: selecting, between the at least one neighbour cell and the at least one further neighbour cell, a cell for the handover of the user equipment based on the determination; and providing the request message for handover to the network access node serving the selected cell.

In an example, at least one of: the second network access node serves a plurality of cells, the cell information comprising: per cell of the plurality of cells, a list of network slices that are supported by the respective cell, and non-uniformly supported in a tracking area of the respective cell; and the third network access node serves a plurality of cells, the further cell information comprising: per cell of the plurality of cells, a list of network slices supported by the respective cell, and non-uniformly supported in a tracking area of the respective cell.

In an example, the cell information comprises cell group mapping information for the tracking area of the at least one neighbour cell, wherein the cell group mapping information maps the at least one neighbour cell to at least one group, the at least one group representing a list of slices that are non-uniformly supported in the tracking area of the respective cell.

In an example, the means are configured to perform: receiving group mapping information for a tracking area of the at least one cell, wherein the group mapping information maps the respective tracking area to the at least one group, the at least one group comprising a list of network slices that are non-uniformly supported in the tracking area.

In an example, the further cell information comprises cell group mapping information for the tracking area of the at least one further neighbour cell, wherein the cell group mapping information maps the at least one further neighbour cell to at least one group, the at least one group representing a list of slices that are non-uniformly supported in the tracking area of the respective cell.

In an example, the means are configured to perform: receiving group mapping information for a tracking area of the at least one further neighbour cell, wherein the group mapping information maps the respective tracking area to the at least one group, the at least one group comprising a list of network slices that are non-uniformly supported in the tracking area.

In an example, the first message is one of: an Xn setup request message; an Xn setup response message; an Xn NG-RAN Node Configuration update message; a self-organising network configuration transfer message; a next-generation radio access network node configuration update message; an uplink radio access network configuration transfer; a downlink radio access network configuration transfer; an E2 setup procedure; an E2 update procedure.

In an example, the self-organising network configuration transfer message is received at the first network access node via the 5G core network.

In an example, the request message for handover of the user equipment is one of: an Xn application protocol Handover Request message; a next-generation application protocol Handover Request message.

In an example, the network slices in the list of network slices are each identified with single-network slice selection assistance information.

According to an aspect, there is provided an apparatus comprising: one or more processors, and memory storing instructions that, when executed by the one or more processors, cause the apparatus to perform: obtaining cell information comprising a list of network slices supported by at least one neighbour cell neighbouring a serving cell, wherein the network slices in the list are non-uniformly supported in a tracking area associated with the at least one neighbour cell; and identifying, using the obtained cell information, a target cell from the at least one neighbour cell that supports a network slice currently used by a user equipment, for performing a change from the serving cell to the target cell.

In an example, the cell information is obtained from a network management function of the first network access node.

In an example, the apparatus is caused to perform: receiving, from a second network access node serving the at least one neighbour cell, the cell information in a first message.

In an example, the apparatus is caused to perform: providing, to the second network access node, a request message identifying the target cell for a handover of the user equipment.

In an example, the change from the serving cell to the target cell is performed by triggering a redirection procedure towards the user equipment.

In an example, the RRC redirection is triggered by the first network access node, in response to the UE initiating a registration procedure and the first network access node learning about the allowed network slices for the UE from an AMF through an initial context setup request.

In an example, the redirection procedure in an RRC redirection procedure.

In an example, the redirection is performed toward a frequency that is associated with the target cell.

In an example, the apparatus is caused to perform: in response to determining that the at least one neighbour cell belonging to a second network access node does not support the network slice, refraining from providing the handover request message to the second network access node. In an example, the network slice being used by the user equipment is non-uniformly supported in a tracking area associated with the serving cell.

In an example, the first network access node serves the user equipment. In an example, the first network access node provides the serving cell.

In an example, the network slice is being used in a protocol data unit session between the first network access node and the user equipment.

In an example, the first message comprises an indication of the tracking area that the at least one cell is comprised in.

In an example, the apparatus is caused to perform: receiving, from a third network access node serving at least one further neighbour cell, further cell information in a second message, wherein the further cell information comprises a list of network slices that are non-uniformly supported by the at least one further neighbour cell.

In an example, the apparatus caused to perform the determining is further caused to perform: determining, using the cell information and further cell information, whether the at least one neighbour cell and/or the at least one further neighbour cell supports the network slice.

In an example, the apparatus caused to perform: in response to determining that both the least one neighbour cell and the at least one further neighbour cell support the network slice, providing the request message comprising an indication that both the least one neighbour cell and the at least one further neighbour cell are candidates for the handover of the user equipment.

In an example, the apparatus caused to perform: selecting, between the at least one neighbour cell and the at least one further neighbour cell, a cell for the handover of the user equipment based on the determination; and providing the request message for handover to the network access node serving the selected cell.

In an example, at least one of: the second network access node serves a plurality of cells, the cell information comprising: per cell of the plurality of cells, a list of network slices that are supported by the respective cell, and non-uniformly supported in a tracking area of the respective cell; and the third network access node serves a plurality of cells, the further cell information comprising: per cell of the plurality of cells, a list of network slices supported by the respective cell, and non-uniformly supported in a tracking area of the respective cell.

In an example, the cell information comprises cell group mapping information for the tracking area of the at least one neighbour cell, wherein the cell group mapping information maps the at least one neighbour cell to at least one group, the at least one group representing a list of slices that are non-uniformly supported in the tracking area of the respective cell.

In an example, the apparatus caused to perform: receiving group mapping information for a tracking area of the at least one cell, wherein the group mapping information maps the respective tracking area to the at least one group, the at least one group comprising a list of network slices that are non-uniformly supported in the tracking area.

In an example, the further cell information comprises cell group mapping information for the tracking area of the at least one further neighbour cell, wherein the cell group mapping information maps the at least one further neighbour cell to at least one group, the at least one group representing a list of slices that are non-uniformly supported in the tracking area of the respective cell.

In an example, the apparatus caused to perform: receiving group mapping information for a tracking area of the at least one further neighbour cell, wherein the group mapping information maps the respective tracking area to the at least one group, the at least one group comprising a list of network slices that are non-uniformly supported in the tracking area.

In an example, the first message is one of: an Xn setup request message; an Xn setup response message; an Xn NG-RAN Node Configuration update message; a self-organising network configuration transfer message; a next-generation radio access network node configuration update message; an uplink radio access network configuration transfer; a downlink radio access network configuration transfer; an E2 setup procedure; an E2 update procedure.

In an example, the self-organising network configuration transfer message is received at the first network access node via the 5G core network.

In an example, the request message for handover of the user equipment is one of: an Xn application protocol Handover Request message; a next-generation application protocol Handover Request message.

In an example, the network slices in the list of network slices are each identified with single-network slice selection assistance information.

According to an aspect, there is provided a method performed by a first network access node: obtaining cell information comprising a list of network slices supported by at least one neighbour cell neighbouring a serving cell, wherein the network slices in the list are non-uniformly supported in a tracking area associated with the at least one neighbour cell; and identifying, using the obtained cell information, a target cell from the at least one neighbour cell that supports a network slice currently used by a user equipment, for performing a change from the serving cell to the target cell.

In an example, the cell information is obtained from a network management function of the first network access node.

In an example, the method comprises: receiving, from a second network access node serving the at least one neighbour cell, the cell information in a first message.

In an example, the method comprises: providing, to the second network access node, a request message identifying the target cell for a handover of the user equipment.

In an example, the change from the serving cell to the target cell is performed by triggering a redirection procedure towards the user equipment.

In an example, the RRC redirection is triggered by the first network access node, in response to the UE initiating a registration procedure and the first network access node learning about the allowed network slices for the UE from an AMF through an initial context setup request.

In an example, the redirection procedure in an RRC redirection procedure.

In an example, the redirection is performed toward a frequency that is associated with the target cell.

In an example, the method comprises: in response to determining that the at least one neighbour cell belonging to a second network access node does not support the network slice, refraining from providing the handover request message to the second network access node. In an example, the network slice being used by the user equipment is non-uniformly supported in a tracking area associated with the serving cell.

In an example, the first network access node serves the user equipment. In an example, the first network access node provides the serving cell.

In an example, the network slice is being used in a protocol data unit session between the first network access node and the user equipment.

In an example, the first message comprises an indication of the tracking area that the at least one cell is comprised in.

In an example, the method comprises: receiving, from a third network access node serving at least one further neighbour cell, further cell information in a second message, wherein the further cell information comprises a list of network slices that are non-uniformly supported by the at least one further neighbour cell.

In an example, the determining further comprises: determining, using the cell information and further cell information, whether the at least one neighbour cell and/or the at least one further neighbour cell supports the network slice.

In an example, the method comprises: in response to determining that both the least one neighbour cell and the at least one further neighbour cell support the network slice, providing the request message comprising an indication that both the least one neighbour cell and the at least one further neighbour cell are candidates for the handover of the user equipment.

In an example, the method comprises: selecting, between the at least one neighbour cell and the at least one further neighbour cell, a cell for the handover of the user equipment based on the determination; and providing the request message for handover to the network access node serving the selected cell.

In an example, at least one of: the second network access node serves a plurality of cells, the cell information comprising: per cell of the plurality of cells, a list of network slices that are supported by the respective cell, and non-uniformly supported in a tracking area of the respective cell; and the third network access node serves a plurality of cells, the further cell information comprising: per cell of the plurality of cells, a list of network slices supported by the respective cell, and non-uniformly supported in a tracking area of the respective cell.

In an example, the cell information comprises cell group mapping information for the tracking area of the at least one neighbour cell, wherein the cell group mapping information maps the at least one neighbour cell to at least one group, the at least one group representing a list of slices that are non-uniformly supported in the tracking area of the respective cell.

In an example, the method comprises: receiving group mapping information for a tracking area of the at least one cell, wherein the group mapping information maps the respective tracking area to the at least one group, the at least one group comprising a list of network slices that are non-uniformly supported in the tracking area.

In an example, the further cell information comprises cell group mapping information for the tracking area of the at least one further neighbour cell, wherein the cell group mapping information maps the at least one further neighbour cell to at least one group, the at least one group representing a list of slices that are non-uniformly supported in the tracking area of the respective cell.

In an example, the method comprises: receiving group mapping information for a tracking area of the at least one further neighbour cell, wherein the group mapping information maps the respective tracking area to the at least one group, the at least one group comprising a list of network slices that are non-uniformly supported in the tracking area.

In an example, the first message is one of: an Xn setup request message; an Xn setup response message; an Xn NG-RAN Node Configuration update message; a self-organising network configuration transfer message; a next-generation radio access network node configuration update message; an uplink radio access network configuration transfer; a downlink radio access network configuration transfer; an E2 setup procedure; an E2 update procedure.

In an example, the self-organising network configuration transfer message is received at the first network access node via the 5G core network.

In an example, the request message for handover of the user equipment is one of: an Xn application protocol Handover Request message; a next-generation application protocol Handover Request message.

In an example, the network slices in the list of network slices are each identified with single-network slice selection assistance information.

According to an aspect, there is provided a computer program comprising computer executable instructions which when run on one or more processors perform: obtaining cell information comprising a list of network slices supported by at least one neighbour cell neighbouring a serving cell, wherein the network slices in the list are non-uniformly supported in a tracking area associated with the at least one neighbour cell; and identifying, using the obtained cell information, a target cell from the at least one neighbour cell that supports a network slice currently used by a user equipment, for performing a change from the serving cell to the target cell.

According to an aspect, there is provided an apparatus for a second network access node, the second network access node providing at least one neighbour cell, the apparatus comprising means configured to perform: providing, to a first network access node providing a serving cell, cell information comprising a list of network slices supported by the at least one neighbour cell neighbouring the serving cell, wherein the network slices in the list are non-uniformly supported in a tracking area associated with the at least one neighbour cell; and receiving, from the first network access node, a request message identifying a target cell of the at least one neighbour cell for a handover of a user equipment, wherein the target cell supports a network slice currently used by the user equipment.

According to an aspect, there is provided an apparatus comprising: one or more processors, and memory storing instructions that, when executed by the one or more processors, cause the apparatus to perform: providing, to a first network access node providing a serving cell, cell information comprising a list of network slices supported by the at least one neighbour cell neighbouring the serving cell, wherein the network slices in the list are non-uniformly supported in a tracking area associated with the at least one neighbour cell; and receiving, from the first network access node, a request message identifying a target cell of the at least one neighbour cell for a handover of a user equipment, wherein the target cell supports a network slice currently used by the user equipment.

According to an aspect, there is provided a method performed by a second network access node: providing, to a first network access node providing a serving cell, cell information comprising a list of network slices supported by the at least one neighbour cell neighbouring the serving cell, wherein the network slices in the list are non-uniformly supported in a tracking area associated with the at least one neighbour cell; and receiving, from the first network access node, a request message identifying a target cell of the at least one neighbour cell for a handover of a user equipment, wherein the target cell supports a network slice currently used by the user equipment.

According to an aspect, there is provided a computer program comprising computer executable instructions which when run on one or more processors perform: providing, to a first network access node providing a serving cell, cell information comprising a list of network slices supported by the at least one neighbour cell neighbouring the serving cell, wherein the network slices in the list are non-uniformly supported in a tracking area associated with the at least one neighbour cell; and receiving, from the first network access node, a request message identifying a target cell of the at least one neighbour cell for a handover of a user equipment, wherein the target cell supports a network slice currently used by the user equipment.

According to an aspect, there is provided an apparatus for a first network access node, the first network access node providing at least one first cell, the apparatus comprising means configured to perform: receiving, from a second network access node providing at least one second cell, a first message, wherein the first message comprises a list of network slices that are supported by at the least one second cell that are non-uniformly supported by a tracking area of the at least one second cell; receiving downlink data for a user equipment for a network slice; determining, using information received in the first message, whether the at least one second cell supports the network slice; and in response to determining that the at least one second cell supports the network slice, paging the second network access node.

In an example, the paging comprises an indication of the network slice.

In an example, the means are configured to perform: in response to determining that the at least one second cell does not support the network slice, refraining from paging the second network access node.

In an example, the at least one second cell neighbours the at least one first cell.

In an example, the first network access node is the last serving network access node of a user equipment.

In an example, the means are configured to perform: providing, to a second network access node, a second message, wherein the second message comprises a list of network slices that are non-uniformly supported by the at least one first cell in a tracking area of the at least one first cell.

In an example, the means are configured to perform: determining whether the at least one first cell supports the network slice; and in response to determining that the at least one first cell supports the network slice, paging the user equipment from the at least one first cell.

In an example, the first and second network access nodes are both part of a radio access network based notification area of a user equipment in radio resource control inactive state.

In an example, the means are configured to perform: configuring a radio access network paging area, in the paging to second network node, to include cells that support the network slice, based on the determining whether the at least one second cell supports the network slice.

In an example, the means are configured to perform: configuring the radio access network based notification area of the user equipment based on whether the at least one first cell of the first network access node and the at least one second cells of the second network access node supports the network slice, before moving the user equipment to radio resource control inactive state or during an radio access network based notification area update procedure.

In an example, the first message comprises cell group mapping information for the tracking area of the at least one second cell, wherein the cell group mapping information maps the at least one second cell to at least one group, the at least one group representing a list of slices that are non-uniformly supported in the tracking area of the respective cell.

In an example, the means are configured to perform: receiving group mapping information for the tracking area of the at least one second cell, wherein the group mapping information maps the respective tracking area to the at least one group, the at least one group comprising a list of network slices that are non-uniformly supported in the tracking area.

In an example, the second message comprises cell group mapping information for a tracking area of the at least one first cell, wherein the cell group mapping information maps the at least one first cell to at least one group, the at least one group representing a list of slices that are non-uniformly supported in the tracking area of the respective cell.

In an example, the means are configured to perform: receiving group mapping information for the tracking area of the at least one first cell, wherein the group mapping information maps the respective tracking area to the at least one group, the at least one group comprising a list of network slices that are non-uniformly supported in the tracking area.

In an example, when the second network access node serves at least two second cells, receiving, from the second network access node, the first message comprising: per cell of the at least two cells, a list of network slices that are non-uniformly supported by the cell in a tracking area of the cell.

In an example, the means are configured to perform: determining, using information received in the first message, whether the at least two second cells support the network slice; and in response to determining that one of the at least two second cells supports the network slice, paging the second network access node, wherein the paging comprises an indication of the network slice.

In an example, the paging message is an Xn application protocol radio access network paging message.

In an example, the first message and/or second message is one of: an Xn setup request message; an Xn setup response message; an Xn NG-RAN Configuration update message; a next-generation radio access network node configuration update message; an uplink radio access network configuration transfer; a downlink radio access network configuration transfer; an E2 setup procedure; an E2 update procedure.

In an example, the second network access node neighbours the first network access node.

According to an aspect, there is provided an apparatus comprising: one or more processors, and memory storing instructions that, when executed by the one or more processors, cause the apparatus to perform: receiving, from a second network access node providing at least one second cell, a first message, wherein the first message comprises a list of network slices that are supported by at the least one second cell that are non-uniformly supported by a tracking area of the at least one second cell; receiving downlink data for a user equipment for a network slice; determining, using information received in the first message, whether the at least one second cell supports the network slice; and in response to determining that the at least one second cell supports the network slice, paging the second network access node.

In an example, the paging comprises an indication of the network slice.

In an example, the apparatus is caused to perform: in response to determining that the at least one second cell does not support the network slice, refraining from paging the second network access node.

In an example, the at least one second cell neighbours the at least one first cell.

In an example, the first network access node is the last serving network access node of a user equipment.

In an example, the apparatus is caused to perform: providing, to a second network access node, a second message, wherein the second message comprises a list of network slices that are non-uniformly supported by the at least one first cell in a tracking area of the at least one first cell.

In an example, the apparatus is caused to perform: determining whether the at least one first cell supports the network slice; and in response to determining that the at least one first cell supports the network slice, paging the user equipment from the at least one first cell.

In an example, the first and second network access nodes are both part of a radio access network based notification area of a user equipment in radio resource control inactive state.

In an example, the apparatus is caused to perform: configuring a radio access network paging area, in the paging to second network node, to include cells that support the network slice, based on the determining whether the at least one second cell supports the network slice.

In an example, the apparatus is caused to perform: configuring the radio access network based notification area of the user equipment based on whether the at least one first cell of the first network access node and the at least one second cells of the second network access node supports the network slice, before moving the user equipment to radio resource control inactive state or during an radio access network based notification area update procedure.

In an example, the first message comprises cell group mapping information for the tracking area of the at least one second cell, wherein the cell group mapping information maps the at least one second cell to at least one group, the at least one group representing a list of slices that are non-uniformly supported in the tracking area of the respective cell.

In an example, the apparatus is caused to perform: receiving group mapping information for the tracking area of the at least one second cell, wherein the group mapping information maps the respective tracking area to the at least one group, the at least one group comprising a list of network slices that are non-uniformly supported in the tracking area.

In an example, the second message comprises cell group mapping information for a tracking area of the at least one first cell, wherein the cell group mapping information maps the at least one first cell to at least one group, the at least one group representing a list of slices that are non-uniformly supported in the tracking area of the respective cell.

In an example, the apparatus is caused to perform: receiving group mapping information for the tracking area of the at least one first cell, wherein the group mapping information maps the respective tracking area to the at least one group, the at least one group comprising a list of network slices that are non-uniformly supported in the tracking area.

In an example, when the second network access node serves at least two second cells, receiving, from the second network access node, the first message comprising: per cell of the at least two cells, a list of network slices that are non-uniformly supported by the cell in a tracking area of the cell.

In an example, the apparatus is caused to perform: determining, using information received in the first message, whether the at least two second cells support the network slice; and in response to determining that one of the at least two second cells supports the network slice, paging the second network access node, wherein the paging comprises an indication of the network slice.

In an example, the paging message is an Xn application protocol radio access network paging message.

In an example, the first message and/or second message is one of: an Xn setup request message; an Xn setup response message; an Xn NG-RAN Configuration update message; a next-generation radio access network node configuration update message; an uplink radio access network configuration transfer; a downlink radio access network configuration transfer; an E2 setup procedure; an E2 update procedure.

In an example, the second network access node neighbours the first network access node.

According to an aspect, there is provided a method performed by a first network access node, the method comprising: receiving, from a second network access node providing at least one second cell, a first message, wherein the first message comprises a list of network slices that are supported by at the least one second cell that are non-uniformly supported by a tracking area of the at least one second cell; receiving downlink data for a user equipment for a network slice; determining, using information received in the first message, whether the at least one second cell supports the network slice; and in response to determining that the at least one second cell supports the network slice, paging the second network access node.

In an example, the paging comprises an indication of the network slice.

In an example, the method comprises: in response to determining that the at least one second cell does not support the network slice, refraining from paging the second network access node.

In an example, the at least one second cell neighbours the at least one first cell.

In an example, the first network access node is the last serving network access node of a user equipment.

In an example, the method comprises: providing, to a second network access node, a second message, wherein the second message comprises a list of network slices that are non-uniformly supported by the at least one first cell in a tracking area of the at least one first cell.

In an example, the method comprises: determining whether the at least one first cell supports the network slice; and in response to determining that the at least one first cell supports the network slice, paging the user equipment from the at least one first cell.

In an example, the first and second network access nodes are both part of a radio access network based notification area of a user equipment in radio resource control inactive state.

In an example, the method comprises: configuring a radio access network paging area, in the paging to second network node, to include cells that support the network slice, based on the determining whether the at least one second cell supports the network slice.

In an example, the method comprises: configuring the radio access network based notification area of the user equipment based on whether the at least one first cell of the first network access node and the at least one second cells of the second network access node supports the network slice, before moving the user equipment to radio resource control inactive state or during an radio access network based notification area update procedure.

In an example, the first message comprises cell group mapping information for the tracking area of the at least one second cell, wherein the cell group mapping information maps the at least one second cell to at least one group, the at least one group representing a list of slices that are non-uniformly supported in the tracking area of the respective cell.

In an example, the method comprises: receiving group mapping information for the tracking area of the at least one second cell, wherein the group mapping information maps the respective tracking area to the at least one group, the at least one group comprising a list of network slices that are non-uniformly supported in the tracking area.

In an example, the second message comprises cell group mapping information for a tracking area of the at least one first cell, wherein the cell group mapping information maps the at least one first cell to at least one group, the at least one group representing a list of slices that are non-uniformly supported in the tracking area of the respective cell.

In an example, the method comprises: receiving group mapping information for the tracking area of the at least one first cell, wherein the group mapping information maps the respective tracking area to the at least one group, the at least one group comprising a list of network slices that are non-uniformly supported in the tracking area.

In an example, when the second network access node serves at least two second cells, receiving, from the second network access node, the first message comprising: per cell of the at least two cells, a list of network slices that are non-uniformly supported by the cell in a tracking area of the cell.

In an example, the method comprises: determining, using information received in the first message, whether the at least two second cells support the network slice; and in response to determining that one of the at least two second cells supports the network slice, paging the second network access node, wherein the paging comprises an indication of the network slice.

In an example, the paging message is an Xn application protocol radio access network paging message.

In an example, the first message and/or second message is one of: an Xn setup request message; an Xn setup response message; an Xn NG-RAN Configuration update message; a next-generation radio access network node configuration update message; an uplink radio access network configuration transfer; a downlink radio access network configuration transfer; an E2 setup procedure; an E2 update procedure.

In an example, the second network access node neighbours the first network access node.

According to an aspect, there is provided a computer program comprising computer executable instructions which when run on one or more processors perform: receiving, from a second network access node providing at least one second cell, a first message, wherein the first message comprises a list of network slices that are supported by at the least one second cell that are non-uniformly supported by a tracking area of the at least one second cell; receiving downlink data for a user equipment for a network slice; determining, using information received in the first message, whether the at least one second cell supports the network slice; and in response to determining that the at least one second cell supports the network slice, paging the second network access node.

According to an aspect, there is provided an apparatus for a second network access node, the apparatus comprising means configured to perform: providing, to a first network access node providing at least one first cell, a first message, wherein the first message comprises a list of network slices that are supported by at the least one second cell that are non-uniformly supported by a tracking area of the at least one second cell; and when the second access node supports a network slice associated with downlink data received at the first network access node, receiving a paging from the first network access node.

According to an aspect, there is provided an apparatus comprising: one or more processors, and memory storing instructions that, when executed by the one or more processors, cause the apparatus to perform: providing, to a first network access node providing at least one first cell, a first message, wherein the first message comprises a list of network slices that are supported by at the least one second cell that are non-uniformly supported by a tracking area of the at least one second cell; and when the second access node supports a network slice associated with downlink data received at the first network access node, receiving a paging from the first network access node.

According to an aspect, there is provided a method performed by a second network access node: providing, to a first network access node providing at least one first cell, a first message, wherein the first message comprises a list of network slices that are supported by at the least one second cell that are non-uniformly supported by a tracking area of the at least one second cell; and when the second access node supports a network slice associated with downlink data received at the first network access node, receiving a paging from the first network access node.

According to an aspect, there is provided a computer program comprising computer executable instructions which when run on one or more processors perform: providing, to a first network access node providing at least one first cell, a first message, wherein the first message comprises a list of network slices that are supported by at the least one second cell that are non-uniformly supported by a tracking area of the at least one second cell; and when the second access node supports a network slice associated with downlink data received at the first network access node, receiving a paging from the first network access node. A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations:

AF Application Function
AMF: Access Management Function
AN: Access Network
BS: Base Station
CN: Core Network
DL: Downlink
eNB: eNodeB
gNB: gNodeB
IIoT: Industrial Internet of Things
LTE: Long Term Evolution
NEF: Network Exposure Function
NG-RAN: Next Generation Radio Access Network
NGAP: Next Generation Application Protocol
NF: Network Function
NR: New Radio
NRF: Network Repository Function
NW: Network
MS: Mobile Station
PCF Policy Control Function
PCI: Physical Cell Identity
PDU: Protocol Data Unit
PLMN: Public Land Mobile Network
RA: Registration Area
RAN: Radio Access Network
RF: Radio Frequency
RRC: Radio Resource Control
SMF: Session Management Function
S-NSSAI: Single-Network Slice Selection Assistance Information
SON: Self-organising Network
TA: Tracking Area
UE: User Equipment
UDR: Unified Data Repository
UDM: Unified Data Management
UL: Uplink
UPF: User Plane Function
XnAP: Xn Application Protocol
3GPP: 3rd Generation Partnership Project
5G: 5th Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of the format of S-NSSAI;

FIG. 5 shows example signalling of network slice support information exchange over Xn;

FIG. 6 shows an example signalling diagram between a user equipment and network entities;

FIG. 7 shows another example signalling diagram between a user equipment and network entities;

FIG. 8 shows another example signalling diagram between a user equipment and network entities;

FIG. 9 shows another example signalling diagram between a user equipment and network entities;

FIG. 10 shows an example method flow diagram performed by a network access node;

FIG. 11 shows another example method flow diagram performed by a network access node;

FIG. 12 shows an example method flow diagram performed by a network access node; and

FIG. 13 shows a schematic representation of a non-volatile memory medium storing instructions which when executed by a processor allow a processor to perform one or more of the steps of the method of FIGS. 10 to 12.

### DETAILED DESCRIPTION

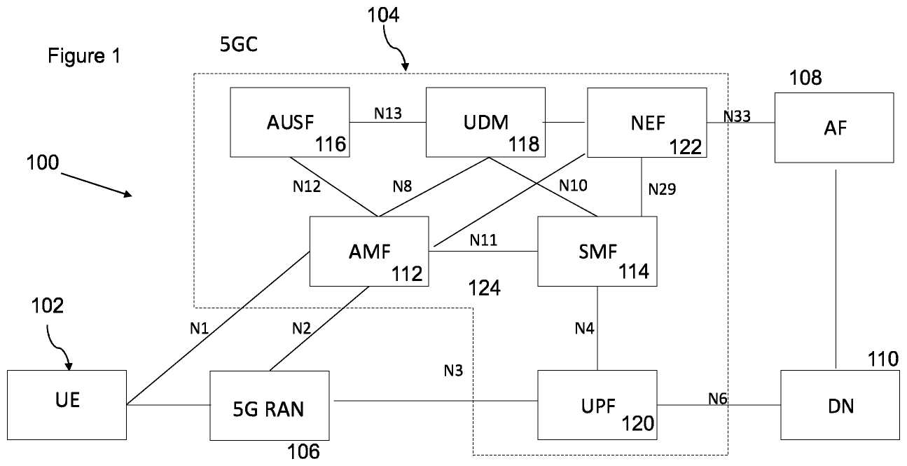

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprise a device 102 such as user equipment or terminal, a 5G access network (5G-AN) 106, a 5G core network (5GC) 104, one or more network functions (NF), one or more application function (AF) 108 and one or more data networks (DN) 110.

The 5G-AN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 4G, 3G, beyond 5G, 6G, etc., and other 3GPP standards.

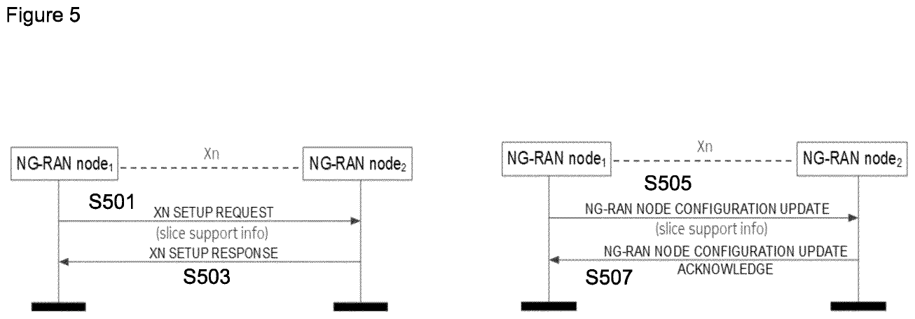

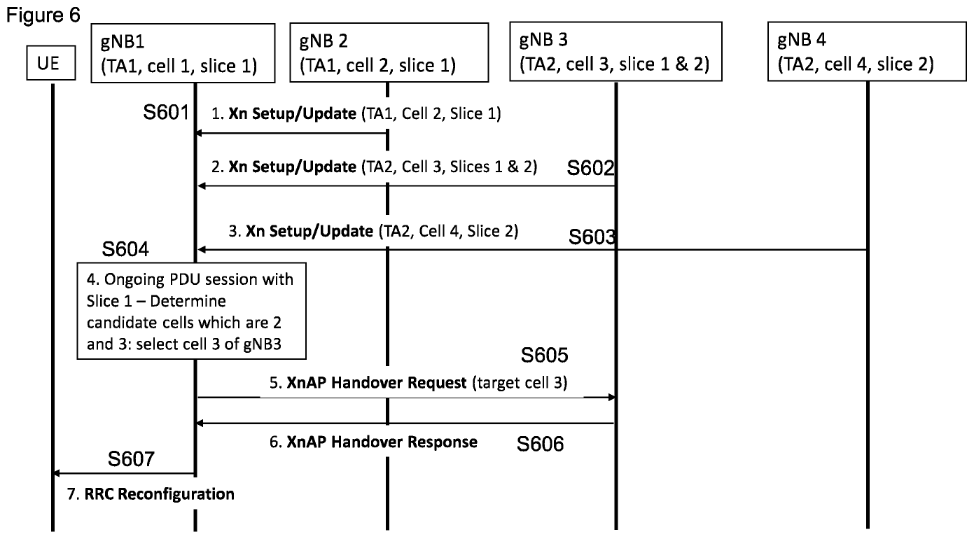

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier. Terminal 102 is also depicted in FIG. 5, with labels 10, 16, 19, 20A, 20B. Terminal 102 is also depicted in FIG. 6 with label 601, for example. The terminal 102 may use communications services. Two or more terminals may use the same communications services. In other examples, two or more terminals may have different services from each other.

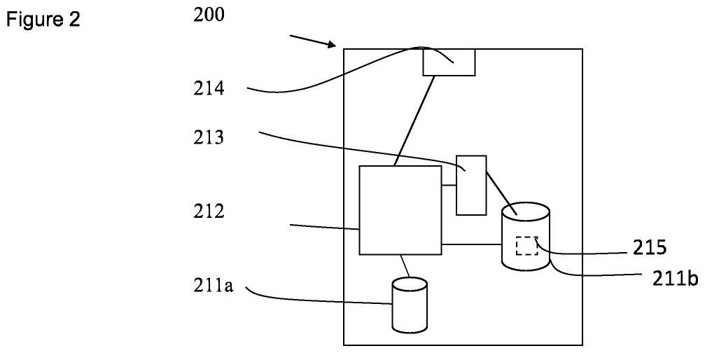

FIG. 2 illustrates an example of a control apparatus 200 for controlling a function of the 5G-AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

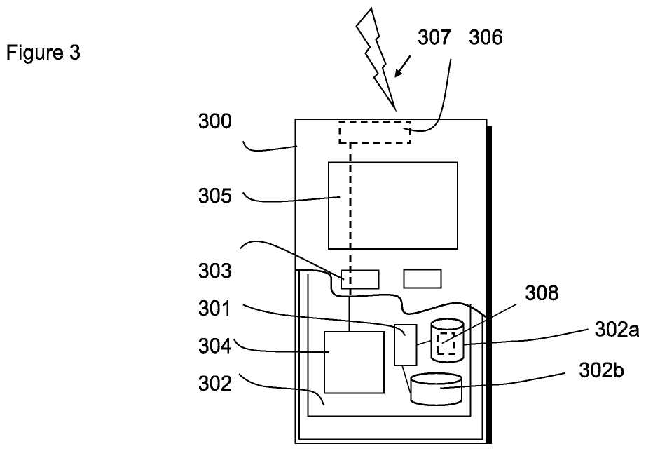

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Some of the following examples are relevant to 5G. Network slicing is a key 5G feature which allows support for different services using the same underlying mobile network infrastructure. Network slices, or simply slices, can differ either in their service requirements like, for example, Ultra-Reliable Low Latency Communication (URLLC) and enhanced Mobile Broadband (eMBB) or the architecture that provides those services. While some of the following examples are relevant to 5G, it should be understood that examples may also be relevant to other standards (for example, open radio access network (O-RAN)) and other mobile and wireless communication systems.

A network slice may be identified via a single-network slice selection assistance information (S-NSSAI). In some example specifications, a user equipment can be simultaneously connected and served by a maximum of eight slices corresponding to eight S-NSSAIs. On other hand, a cell may support tens or hundreds of slices. For example, in some specifications, a tracking area (TA) can have a support up to 1024 network slices.

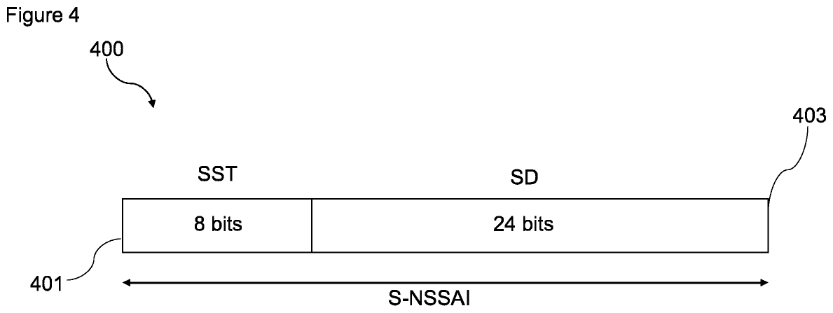

FIG. 4 shows a schematic representation of the format of S-NSSAI. The S-NSSAI 400 includes both a slice service type (SST) 401 and a slice differentiator (SD) field 403. The S-NSSAI 400 may have a total length of 32 bits. Alternatively, the S-NSSAI may include only SST field 401 part in which case the length of S-NSSAI 400 is 8 bits. The SST field 401 may have standardized and non-standardized values. Values 0 to 127 may belong to the standardized SST range. For instance, SST value of 1 may indicate that the slice is suitable for handling of 5G eMBB, 2 for handling of URLLC, etc. The SD field 403 is operator-defined.

Neighbouring gNBs may exchange network slice support information per tracking area over the Xn interface during Xn Set-Up and next generation radio access network (NG-RAN) node configuration update procedures. This exchange is shown in FIG. 5. FIG. 5 shows example signalling of network slice support information exchange over Xn.

At S501, a first NG-RAN node provides an Xn setup request message to a second NG-RAN node, wherein the message comprises network slice support information per TA.

At S503, the second NG-RAN node provides an Xn setup response message to the first NG-RAN node, wherein the message comprises network slice support information per TA.

At S505, the first NG-RAN node provides an NG-RAN node configuration update message to the second NG-RAN node, wherein the message comprises network slice support information per TA.

At S507, the second NG-RAN provides an NG-RAN node configuration update acknowledgment message to the first NG-RAN.

In wireless networks, a registration area (RA) can be defined as a list of Tracking Areas (TAs) for a UE. When a UE registers to a network the UE can indicate the network slices to which it might need access. This may be referred to as “requested S-NSSAIs” in a message sent by the UE. The core network analyses the UE profile and subscription data to verify the list of network slices that the UE can really have access to. As a result, the core network sends a list of “allowed S-NSSAIs” to the UE. The list of allowed slices could be different, or only a subset of, the “requested S-NSSAIs” from the UE request in registration process.

A reason why the UE may not have access to a specific network slice may be that the network slice is not supported in the TA in which the registration request was initiated. If the allowed network slices contain one or more network slices, then the core network also configures an RA for that UE. This RA contains a list of TAs in which all of the allowed slices of the UE are supported. The core network knows the current TA of the UE from the registration request. In some example scenarios, the core network can configure the list of TAs for the UE in which the slice support is homogenous for the requesting UE. Once the UE goes outside (moves out) of the TAs in the Registration Area, the UE will perform a registration area update, and the core network re-evaluates the UE requested slices to configure a new registration area. By allocating different lists of tracking areas to different UEs, the operator can give UEs different registration area borders and so reduce peaks in registration update signalling, for example when a train passes a TA border.

The core network knows the location of an idle UE in RM-REGISTERED state in terms of an RA. Thus, in case of a network-originated service request, the AMF pages the gNBs belonging to the TAs of the RA. The AMF can apply different paging policies when performing said paging. For example, page only part of the RA considering the last TA where the UE made the RA update. Thus, there is a trade-off between the size of the RA and paging overhead versus the RA update frequency. In other words, a large RA implies fewer RA updates but more paging signalling. A small RA implies more RA updates but less paging signalling. In addition, with the smaller RA, the UE could be reached faster (with paging) and thus might be preferred for certain services with delay constraints. Thus, in some situations, a UE belonging to a network slices with large coverage areas might be configured with a RA that does not include all of the TAs in which the slice is supported but only a subset of the TAs, based on the current TA of the UE.

Some of the following examples are related to RRC_INACTIVE. RRC_INACTIVE is a state where a UE remains in connection management connected mode (CM-CONNECTED) and can move within an area configured by NG-RAN without notifying NG-RAN. The area configured by the NG-RAN is called a radio access network (RAN) based notification area (RNA). In RRC_INACTIVE, the last serving gNB node keeps the UE context and the UE-associated next-generation (NG) connection with the serving AMF and UPF. A UE in the RRC_INACTIVE state shall initiate an RNA update procedure when it moves out of the configured RNA. The RNA will be discussed in more detail below.

A UE in the RRC_INACTIVE state can be configured by the last serving NG-RAN node with an RNA, wherein the RNA can cover a single or multiple cells, and shall be contained within the core network (CN) registration area (RA). In some examples, Xn connectivity is available within the RNA.

A RAN-based notification area update (RNAU) is periodically sent by the UE and is also sent when the cell reselection procedure of the UE selects a cell that does not belong to the configured RNA.

There are several different alternatives on how the RNA can be configured:
A list of cells:
   A UE is provided with an explicit list of cells that make up the RNA.
List of RAN areas:
   A UE is provided with (at least one) RAN area ID, where a RAN area is a subset of a CN Tracking Area or equal to a CN Tracking Area. A RAN area is specified by one RAN area ID, which comprises a tracking area code (TAC) and optionally, a RAN area Code;
   A cell broadcasts one or more RAN area IDs in the system information.

The NG-RAN may provide different RNA definitions to different UEs. The NG-RAN may not mix different definitions to the same UE at the same time. In examples, the UE may support all RNA configuration options listed above.

In current specifications, there is homogeneous support for network slices throughout the TAs of an RA. The homogenous support means that each TA within the RA supports the same network slices. This means there is uniform support for a list of network slices (S-NSSAIs) throughout an RA. In current specifications, a UE will receive signalling such that the UE is aware of all uniformly supported network slices within the RA.

It has been identified that it is desirable to configure additional network slices in ‘hot spots’ or other specific areas. The additional network slices may not be supported throughout the whole TA. Therefore, the additional network slices may not be supported throughout the RA also. In this way, the additional network slices are non-uniformly supported network slices. It may be desirable to configure these additional network slices in a specific area due to, for example, a large sporting event, or a music concert or for augmented reality (AR) gaming. The concentrated amount of people moving to a relatively small area may put a strain on the network. The additional network slices for area may reduce said strain. The additional network slices may be temporarily supported in the area. In this way, one or more cells of a TA will support (possibly temporarily) additional network slices compared to the basic set of slices homogeneously/uniformly supported in the TA. In the following examples, if a network slice is supported by all cells of a TA/RA then this is referred to as uniform support of the network slice. If a network slice is not supported by all cells of a TA/RA, then this is referred to as non-uniform support of the network slice.

In some situations, a few cells of a TA will support additional network slices compared to the basic set of slices homogeneously supported in the TA. If there is a handover, then a UE could have an ongoing protocol data unit (PDU) session associated with a network slice which is not uniformly supported in the TA. The UE may lose this PDU session if the UE handed over to a neighbour cell which doesn't support the associated slice. Furthermore, in the case of RRC inactive UEs, an anchor gNB may receive incoming traffic for a PDU session associated with a network slice which is non-uniformly supported in TA. The anchor gNB may uselessly send Xn Paging to neighbour gNBs which belong to UE RNA but have no cells supporting the incoming network slice. This would be a waste of network resources.

There is a need to inform the user equipments of the non-uniformly supported network slices without redefining the whole TA. It had been proposed to broadcast, in those cells with the additional network slice support, these additional slices to the UEs. However, each slice ID comprises 32 bits and so this option would not be scalable particularly considering the number of slices that may be supported by a cell. This would use excessive network resources. In some implementations, an index may be defined for each combination of network slice support throughout the RA, wherein each index refers to a pre-defined list of network slices which is unique throughout the PLMN. However, the number of combinations of N slices in a PLMN where N can have multiple values is an exponential combinatory. In this way, excessive network resources would be used. One or more of the examples below aims to address one or more of the problems identified above.

In some examples, a network access node is able to obtain cell information comprising a list of network slices supported by at least one neighbour cell neighbouring a serving cell, wherein the network slices in the list are non-uniformly supported in a tracking area associated with the at least one neighbour cell. The network access node also able to identify, using the obtained cell information, a target cell from the at least one neighbour cell that supports a network slice currently used by a user equipment, for performing a change from the serving cell to the target cell. For example, a base station/network access node (e.g. gNB), which serves a cell, exchanges in an Xn Setup procedure and/or an NG-RAN Node Configuration update procedure, messages including cell information comprising a list of network slices that are supported by the cell that are non-uniformly supported in a tracking area of the cell. An Xn Setup procedure and/or an NG-RAN Node Configuration update procedure may be simply referred to as Xn Setup/Update. If the gNB supports a plurality of cells, then the cell information would be provided per cell. The messages can also include information on the uniformly supported slices. In the case of a handover, a source gNB can use the information to prioritise a selection of a target cell based on the support of a network slice. For example, the source gNB can continue a PDU session which is associated with a particular network slice, which can maximize the service continuity of the ongoing PDU session. This may be particularly beneficial for the non-uniformly supported slices.

In some examples, a network access node which provides a first cell is able to receive, from another network access node which provides at least one second cell, a first message, wherein the first message comprises a list of network slices that are supported by at the least one second cell that are non-uniformly supported by a tracking area of the at least one second cell. The network access node is also able to receive downlink data for a user equipment for a network slice, and determine, using information received in the first message, whether the at least one second cell supports the network slice. In response to determining that the at least one second cell supports the network slice, the network access node is able to page the second network access node.

For example, in the case of Xn Paging, an anchor gNB can use the information to exclude from paging those neighbour gNBs in which all cells of the UE RNA do not support the network slice associated with any incoming data traffic. In an example, the anchor gNB may use the information to limit the RAN paging area only to relevant cells. In another example, the anchor gNB can send the S-NSSAI associated with any incoming data traffic in the Xn RAN Paging message to another gNB. The paged gNB may then limit (itself) the RAN paging area to relevant cells only i.e. only cell(s) that are involved with the received S-NSSAI. In some examples, a serving gNB, while configuring the RNA in the UE, may consider the cells of the serving gNB and neighbouring gNBs that support the network slice allowed for the UE. This may take place before moving the UE to an RRC inactive state or during an RNA update procedure.

This will be described in more detail below.

FIG. 6 shows an example signalling diagram between a user equipment and network entities. The communications are between four gNodeBs and a user equipment. A first gNB is associated with TA1, provides cell 1, and supports network slice 1. A second gNB is associated with TA1, provides cell 2, and supports network slice 1. A third gNB is associated with TA2, provides cell 3, and supports network slices 1 and 2. A fourth gNB is associated with TA2, provides cell 4, and supports network slice 2. It should be understood that the associations and support shown in FIG. 6 are shown as an example only.

At S601, gNB2 provides a first message to gNB1. The first message may comprise cell information which includes the cell (i.e. cell 2) and which network slice(s) (i.e. slice 1) are supported by the cell. The slice support information may be provided on a cell level. In this example, the network slices that are indicated are non-uniformly supported in TA1 associated with the cell. The first message may also identify the TA that the cell is associated with (i.e. TA1). In some embodiments, the messages may include information on the uniformly supported slices and non-uniformly supported slices. The slice support information for the uniformly supported slices may be provided per TA, while the slice support information for the non-uniformly supported slices may be provided per cell. In an example, the first message may be an Xn setup request message. In another example, the first message may be an NG-RAN Node Configuration update message. In another example, the first message may be an update message. In some embodiments, the response messages to the aforementioned messages may also include slice support information.

At S602, gNB3 provides a second message to gNB1. The second message may comprise cell information which identifies cell 3, and slices 1 & 2 which are non-uniformly supported in the TA of cell 3, in this example. The second message may also identify TA2. In an example, the second message may be an Xn setup request message. In another example, the second message may be an NG-RAN Node Configuration update message. In an example, the second message may be an update message. In some embodiments, the messages may include information on the uniformly supported slices and non-uniformly supported slices. The slice support information for the uniformly supported slices may be provided per TA, while the slice support information for the non-uniformly supported slices may be provided per cell. In some embodiments, the response messages to the aforementioned messages may also include slice support information.

At S603, gNB4 provides a third message to gNB1. The third message may comprise cell information which identifies cell 4, and slice 2 which is non-uniformly supported in the TA of cell 4, in this example. The second message may also identify TA2. In an example, the third message may be an Xn setup request message. In another example, the third message may be an NG-RAN Node Configuration update message. In an example, the third message may be an update message. In some embodiments, the messages may include information on the uniformly supported slices and non-uniformly supported slices. The slice support information for the uniformly supported slices may be provided per TA, while the slice support information for the non-uniformly supported slices may be provided per cell. In some embodiments, the response messages to the aforementioned messages may also include slice support information.

In the example of FIG. 6, cell information for three cells is received from three gNBs. In other examples, at least two pieces of cell information is received from at least one gNB. For example, one gNB may provide cell information for two different cells that the gNB supports.

In the example of FIG. 6, the cell information is received from neighbouring cells. In other examples, the cell information is obtained from a network management function of gNB1. For example, the cell information is configured by operation and management (O&M).

At S604, there is an ongoing protocol data unit (PDU) session between gNB1 and the UE. Cell 1 is the serving cell for the UE. The ongoing PDU session may be associated with network slice 1. Network slice 1 may not be uniformly supported in TA1 and/or neighbour TAs such as TA2. In some embodiments, the UE may have more than one PDU session. Each PDU session may be associated with more than one network slice.

The gNB1 determines which neighbour cells support network slice 1 using the cell information (received or obtained). In the example of FIG. 6, cells 2 and 3 support network slice 1. Following the determination, gNB1 selects cell 3 which is provided by gNB3. In this way, cell 3 is selected as the target cell. The selection of the target cell may be, for example, due to mobility events such as handover (HO), conditional handover (CHO), or dual active protocol stack (DAPS) HO, or due to redirection of the UE to another cell, for example, considering the slices associated with the UE and/or load balancing.

In other examples, gNB1 selects cell 2. If there are multiple cell candidates, then a UE measurement report may be considered by gNB1 when selecting the cell.

At S605, gNB1 provides a request for handover message to the selected cell, cell 3 (gNB3). In an example the request for handover message may be an Xn application protocol (XnAP) handover request message.

At S606, gNB3 provides a response message to gNB1. The response message may be an XnAP handover response message.

In the example of FIG. 6, the selected cell is provided by a different gNB than the serving gNB. In some examples, gNB1 may provide a plurality of cells and one of the other cells provided by gNB1 is selected for handover (i.e. inter-cell handover). In this situation, gNB1 would not provide a handover request message. Instead, gNB1 would initiate a change (or re-direct) from the serving cell to the target cell. In some embodiments, gNB1 may send a HO request message including a plurality of candidate cells to a target gNB and the target gNB may select one of these cells as the target cell for the handover.

At S607, gNB1 provides a radio resource control (RRC) reconfiguration message to the UE. In some embodiments, gNB1 can provide redirection information in an RRCRelease message. The redirection information can be in the form of, for example, carrier information, such as redirected carrier information, or in the form of a cell ID or TA ID, such as TA code (TAC).

In another example, instead of selecting a target cell from the list of candidate cells, the gNB1 provides the list of candidate cells to one or more gNBs (i.e. gNB3). Then gNB3 can use the list of candidate cells to decide which cell should be used as a target cell.

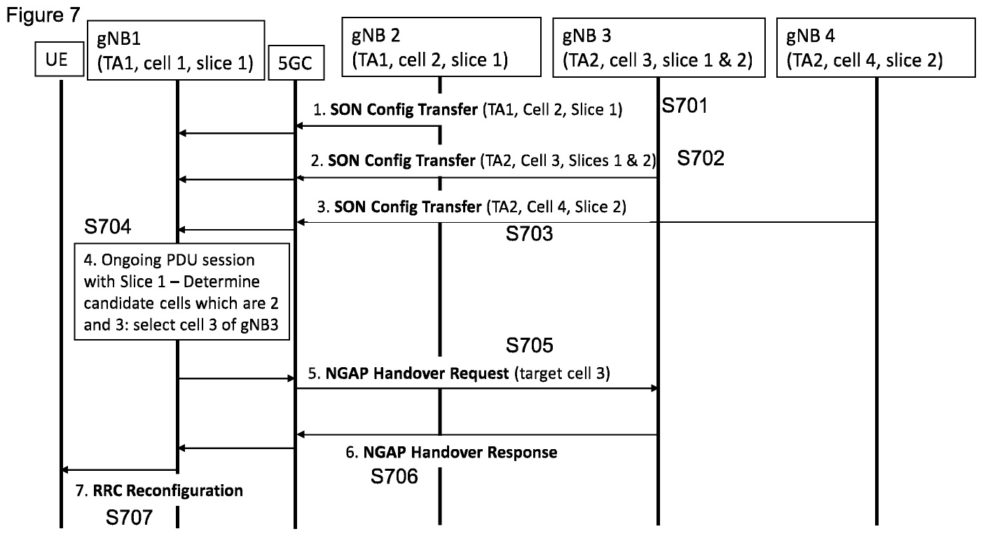

FIG. 7 shows another example signalling diagram between a user equipment and network entities. The communications are between four gNodeBs, a 5G core network (5GC), and a user equipment. A first gNB is associated with TA1, provides cell 1, and supports network slice 1. A second gNB is associated with TA1, provides cell 2, and supports network slice 1. A third gNB is associated with TA2, provides cell 3, and supports network slices 1 and 2. A fourth gNB is associated with TA2, provides cell 4, and supports network slice 2. It should be understood that the associations and support shown in FIG. 7 are shown as an example only.

At S701, gNB2 provides a first message to gNB1 via the 5GC. The first message may comprise cell information which includes the cell (i.e. cell 2) and which network slice(s) (i.e. slice 1) are supported by the cell. The network slices that are indicated are non-uniformly supported in TA1 associated with the cell in this example. The first message may also identify the TA that the cell is associated with (i.e. TA1). In an example, the first message may be a self-organising network (SON) configuration transfer message. In some embodiments, core network entity is relaying the received message from one gNB to the target gNB. In some embodiments, the messages may include information on the uniformly supported slices and non-uniformly supported slices. The slice support information for the uniformly supported slices may be provided per TA, while the slice support information for the non-uniformly supported slices may be provided per cell. In some embodiments, the response messages to the aforementioned messages may also include slice support information.

At S702, gNB3 provides a second message to gNB1 via the 5GC. The second message may comprise cell information which identifies cell 3, and slices 1 & 2 which are non-uniformly supported in the TA of cell 3, in this example. The second message may also identify TA2. In an example, the second message may be a self-organising network (SON) configuration transfer message. In some embodiments, the messages may include information on the uniformly supported slices and non-uniformly supported slices. The slice support information for the uniformly supported slices may be provided per TA while the slice support information for the non-uniformly supported slices may be provided per cell. In some embodiments, the response messages to the aforementioned messages may also include slice support information.

At S703, gNB4 provides a third message to gNB1. The third message may comprise cell information which identifies cell 4, and slice 2 which is non-uniformly supported in the TA of cell 4, in this example. The second message may also identify TA2. In an example, the second message may be a self-organising network (SON) configuration transfer message. In some embodiments, the messages may include information on the uniformly supported slices and non-uniformly supported slices. The slice support information for the uniformly supported slices may be provided per TA, while the slice support information for the non-uniformly supported slices may be provided per cell. In some embodiments, the response messages to the aforementioned messages may also include slice support information.

In the example of FIG. 7, the cell information is received from neighbouring cells. In other examples, the cell information is obtained from a network management function of gNB1. For example, the cell information is configured by operation and management (O&M).

At S704, there is an ongoing protocol data unit (PDU) session between gNB1 and the UE. Cell 1 is the serving cell for the UE. The ongoing PDU session may be associated with network slice 1. Network slice 1 may not be uniformly supported in TA1 and/or neighbour TAs such as TA2. In some embodiments, the UE may have more than one PDU session. Each PDU session may be associated with more than one network slice. The gNB1 determines which neighbour cells support network slice 1 using the cell information (received or obtained). In the example of FIG. 6, cells 2 and 3 support network slice 1. Following the determination, gNB1 selects cell 3 which is provided by gNB3. In this way, cell 3 is selected as the target cell.

In other examples, gNB1 selects cell 2. If there are multiple cell candidates, then a UE measurement report may be considered by gNB1 when selecting the cell.

At S705, gNB1 provides a request for handover message to the selected cell, cell 3 (gNB3), via the 5GC. In an example the request for handover message may be next-generation application protocol (NGAP) handover request message.

At S706, gNB3 provides a response message to gNB1 via the 5GC. The response message may be an NGAP handover response message.

In the example of FIG. 7, the selected cell is provided by a different gNB than the serving gNB. In some examples, gNB1 may provide a plurality of cells and one of the other cells provided by gNB1 is selected for handover (i.e. inter-cell handover). In this situation, gNB1 would not provide a handover request message. Instead, gNB1 would initiate a change (or re-direct) from the serving cell to the target cell. In some embodiments, gNB1 may send a HO request message including a plurality of candidate cells to target gNB and the target gNB may select one of these cells as the target cell for the handover.

At S707, gNB1 provides a radio resource control (RRC) reconfiguration message to the UE. In some embodiments, gNB1 can provide redirection information in an RRCRelease message. The redirection information can be in the form of, e.g., carrier information, such as redirected carrier information, or in the form of a cell ID or TA ID, such as TA code (TAC).

In another example, instead of selecting a target cell from the list of candidate cells, the gNB1 provides the list of candidate cells to one or more gNBs (i.e. gNB3). Then gNB3 can use the list of candidate cells to decide which cell should be used as a target cell.

In some examples, in FIG. 6 and/or FIG. 7, the first message may be one of: an Xn setup request message; an Xn NG-RAN Configuration update message; a self-organising network configuration transfer message; a next-generation radio access network node configuration update message; an uplink radio access network configuration transfer; a downlink radio access network configuration transfer; an E2 setup procedure; an E2 update procedure.

In another example, in a case of NG-based handover, the 5GC (e.g. AMF) provides the network slice support of neighbour TAs using NGAP procedures. In this example, a RAN node first informs the 5GC of the RAN topology along with network slice support. Then the 5GC informs each RAN node about the neighbours that the RAN node does not know about.

In FIGS. 6 and 7, there is provided a mechanism whereby the network slices that are non-uniformly supported across a tracking area are exemplarily considered for mobility/handover decisions. This results in an improved service continuity as a UE can be handed over to a cell that supports an ongoing session of the UE. This also leads to a reduced signalling overhead as handovers will be reduced.

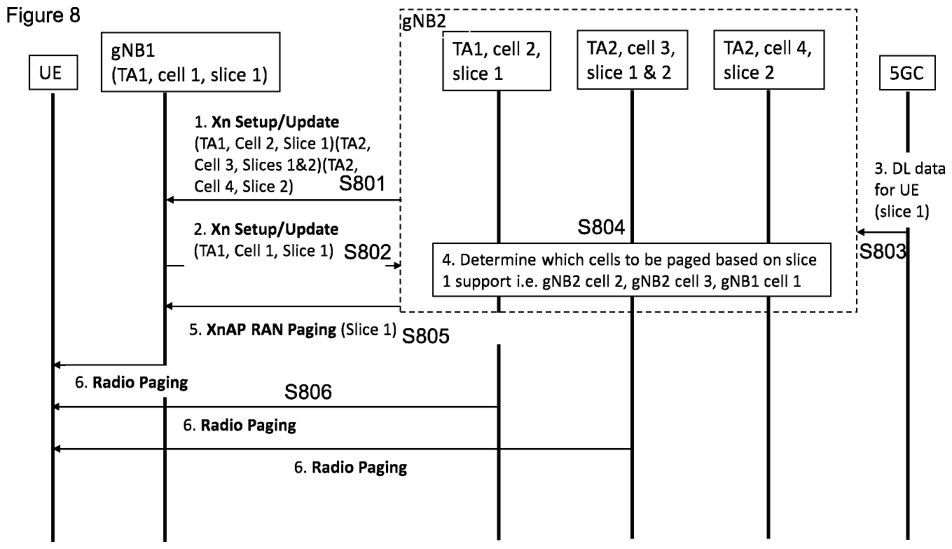

FIG. 8 shows another example signalling diagram between a user equipment and network entities. Communications are between a UE, a first gNB (gNB1), a second gNB (gNB2), and a 5GC. In this example, gNB1 provides cell 1 which is associated with TA1, which supports network slice 1. gNB2 provides cell 2 which is associated with TA1, which supports network slice 1. gNB2 also provides cell 3 which is associated with TA2, which supports network slices 1 and 2. gNB2 also provides cell 4 which is associated with TA2, which supports network slice 2. gNB1 and gNB2 may neighbour one another.

In the example of FIG. 8, the UE is in RRC inactive mode.

At S801, gNB2 provides a first message to gNB1. The first message may comprise cell information for the cells provided by gNB2. In this example, the first message indicates that cell 2 supports slice 1, that cell 3 supports slices 1 and 2, and that cell 4 supports slice 2. The first message may also indicate which TA is associated with each cell. In an example, the first message may be an Xn setup request message. In another example, the first message may be an NG-RAN Node configuration update message, simply Update message. In some embodiments, the messages may include information on the uniformly supported slices and non-uniformly supported slices. The slice support information for the uniformly supported slices may be provided per TA, while the slice support information for the non-uniformly supported slices may be provided per cell. In some embodiments, the response messages to the aforementioned messages may also include slice support information.

At S802, gNB1 provides a second message to gNB2. The second message may comprise cell information for cell 1 which is provided by gNB1. In this example, the second message indicates that cell 1 supports slice 1. The second message may also indicate that cell 1 is associated with TA1. The network slices that are indicated in S801 and S802 are non-uniformly supported in the TA associated with that cell, in this example. In an example, the second message may be an Xn setup response message, simply part of Xn Setup procedure. In another example, the second message may be an NG-RAN Node configuration update acknowledge message, simply part of Update procedure. In some embodiments, the messages may include information on the uniformly supported slices and non-uniformly supported slices. The slice support information for the uniformly supported slices may be provided per TA, while the slice support information for the non-uniformly supported slices may be provided per cell. In some embodiments, the response messages to the aforementioned messages may also include slice support information.

It should be understood that S802 may occur before S801, or at the same time. For example, the Xn Setup or NG-RAN Configuration Update procedures may be first initiated by gNB1.

At S803, the gNB2 receives downlink data for the UE. The downlink data is associated with a network slice. In this example, slice 1 is the associated network slice.

At S804, the gNB2 determines which cells should be paged. These cells can be within the RNA of the UE. gNB2 uses the received cell information to determine which cells support slice 1. In this example, cell 1 of gNB1, cell 2 of gNB2, and cell 3 of gNB2 support slice 1.

At S805, as gNB2 determined that cell 1 of gNB1 supports slice 1, the gNB2 pages gNB1. In another example, if no cells of gNB1 supported slice 1, then gNB2 would refrain from paging gNB1.

The paging message provided to gNB1 may identify slice 1. The identification of the network slice in the page may be used by gNB1 if gNB1 provides more than one network slice.

The paging message may be, for example, an XnAP RAN paging message.

At S806, all of the cells that support network slice 1 would radio page the UE. In this example, cell 1, cell 2 and cell 3 page the UE.

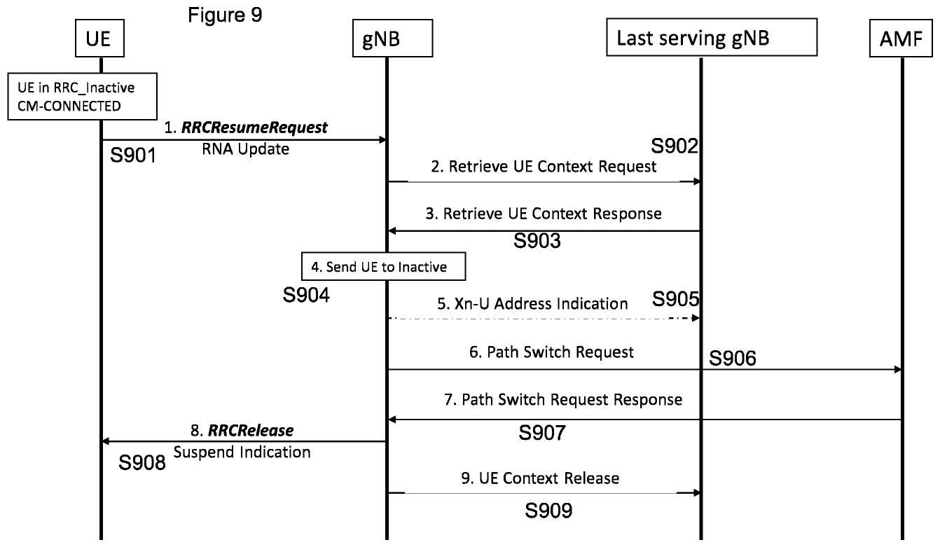

FIG. 9 shows another example signalling diagram between a user equipment and network entities. In this example, the communications are between a UE, a gNB, a last serving gNB and an AMF.

At the start of the signalling between entities, the UE is in RRC inactive, CM-CONNECTED mode.

At S901, the UE provides an RRC resume request message to the gNB. The message also includes a request for an RNA update. For example, the request for an RNA update mat be a cause value.

At S902, the gNB requests the UE context from the last serving gNB.

At S903, the last serving gNB provides the UE context to the gNB in a response message. The UE context may comprise the cell information that may include network slice support of one or more neighbour cells as described in FIG. 8.

At S904, the gNB sends the UE to inactive mode.

At S905, the gNB provides an Xn-U address (user plane address) indication.

At S906, the gNB provides a path switch request to the AMF.

At S907, the AMF provides a path switch request response message to the gNB.

At S908, the gNB provides an RRC release message to the UE. The message may comprise a suspend indication.

At S909, the gNB provides a UE context release message to the last serving gNB.

In the example of FIG. 9, the gNB which decides to send the UE to RRC inactive state (in S904) would update the RAN based notification area (RNA) considering the cells and neighbouring gNBs that support allowed slices for the UE. For example, if the allowed network slices of the UE are slices 1, 2 and 3, then the gNB may update the RNA to select cells which support slices 1, 2 and 3. The gNB may update the RNA before sending the UE to RRC inactive mode, or during an RNA update procedure.

In some examples, the RNA update procedure may be triggered when the UE moves out of the configured RNA. In another example, the RNA update procedure may take place periodically.

In the case of Xn paging, the anchor gNB can use the cell information to exclude from paging those neighbour gNBs in which all cells of the UE RNA are not involved with the slice of the incoming traffic. The anchor gNB may also use the cell information to limit the RAN paging area only to relevant cells. Alternatively, the anchor gNB can send the S-NSSAI(s) in the Xn RAN Paging message (e.g. S805). The paged gNB may limit itself to the RAN paging area to only the relevant cells i.e. the cells involved with the network slice.

In FIGS. 8 and 9, there is provided a mechanism whereby the network slices that are non-uniformly supported across a tracking area are considered for paging decisions. This results in an improved service continuity and a reduced signalling overhead.

In the examples of FIGS. 6 to 9, the support for non-uniformly supported network slices is provided to the network entities as a list. For each cell, a list of network slices is provided. In this context, a list may comprise one or more network slices. Alternatively, a list may comprise zero network slices.

In some examples, during Xn setup procedure and/or NG-RAN Configuration Update procedure, RAN nodes may have exchanged the details of the cells and details of uniformly and/or non-uniformly network slices supported by each cell. When the UE initiates a registration procedure by indicating the requested slices in a registration request, the access and mobility management function (AMF) based on the UE's subscription may indicate the allowed slices in an initial context setup request to the network access node/RAN. The list of allowed slices could be combination of uniformly supported network slices and non-uniformly supported network slices. Based on the allowed network slices, the UE would be attached to a current cell which already supports the allowed slices, and so no further action is needed and registration procedure proceeds as usual. In a case whereby the current cell does not support the non-uniform slice(s), which are part of the allowed slices for the UE, then the RAN would use, for example, an RRC Redirection procedure to re-direct the UE to appropriate target cell and/or frequency, which supports the allowed slice(s). The target cell could be part of the same RAN or could be part of the neighbouring RAN.

In some examples, instead of a list of network slices there is provided group mapping information in combination with cell mapping information. The group mapping information is provided per tracking area (TA). The group mapping information maps a respective tracking area to one or more groups, wherein the one or more groups comprise a list of network slices that are non-uniformly supported in the respective tracking area. The cell mapping information will map a respective cell in a tracking area to one of the groups. This will be described in more detail below.

For each tracking area, one or more groups will be configured. Each group of the one or more groups represents a unique combination of network slices that are non-uniformly supported in that tracking area.

As an example only, there is provided a first TA (TA1). There are four different groups configured for TA1, as follows:
TA1: group 1 (slices 3, 4)
TA1: group 2 (slice 5)
TA1: group 3 (slices 4, 5, 6)
TA1: group 4 (slices 6, 7)

Each group of TA1 shows the network slices that are non-uniformly supported in TA1. In an example, network slices 1 and 2 may be uniformly supported throughout TA1. In this way, any cells in TA1 which support group 1 support slices 1 and 2 (uniformly), as well as slices 3 and 4. Any cells in TA1 which support group 2 support slices 1, 2 and 5. Any cells in TA1 which support group 3 support slices 1, 2, 4, 5, and 6. Any cells in TA1 which support group 4 support slices 1, 2, 6 and 7. It should be understood that four different groups is an example only. In other examples, there may be more or less than four groups per TA.

As there are four groups in TA1, this may efficiently be encoded with 2 bits as:
Group 1 of TA1=00
Group 2 of TA1=01
Group 3 of TA1=10
Group 4 of TA1=11

The above group information is referred to as group mapping information. The group mapping information maps a tracking area to at least one group, the at least one group comprising a list of network slices that are non-uniformly supported in the tracking area.

In the examples shown in FIGS. 6 to 9, each gNB would have received the group mapping information from O&M or from a core network entity.

As per FIGS. 6 to 9 above, the gNBs may then receive cell information as part of the signalling. However, in this example, the cell information comprises cell mapping information. Instead of receiving an identification of a cell with a list of network slices supported by that cell, a gNB may receive an identification of a cell being mapped to a group supported by that cell, for the TA associated with the cell. The group is specific to the TA supported by the cell.

For example, if a gNB supports a single cell, then that gNB may provide:
TA1: [Group 1(supported by cell 1)]

This indicates that cell 1 of TA1 supports group 1. A further gNB which receives this signalling will already know the group mapping information, and can therefore work out which network slices are supported by cell 1.

In another example, a gNB supports a plurality of cells and may provide:
TA1: [Group 1(supported by cell 1), Group 2(supported by cells 2, 3)]

This indicates that cell 1 of TA1 supports group 1. Also, that cells 2 and 3 of TA1 both support group 2. A further gNB receiving this information can determine which network slices each cell supports, using this cell mapping information in combination with the stored group mapping information.

In some examples, when the group mapping information and cell mapping information is implemented, the signalling overhead may be reduced in comparison to sending a list of network slices supported by each cell. The groups are defined per TA making the number of combinations of slices non-uniformly supported per TA quite limited. As discussed above, four different groups can be encoded with only 2 bits. This makes the solution scalable for broadcast.

The features of the group mapping information and cell mapping information may be implemented in any of the examples shown in FIGS. 6 to 9.

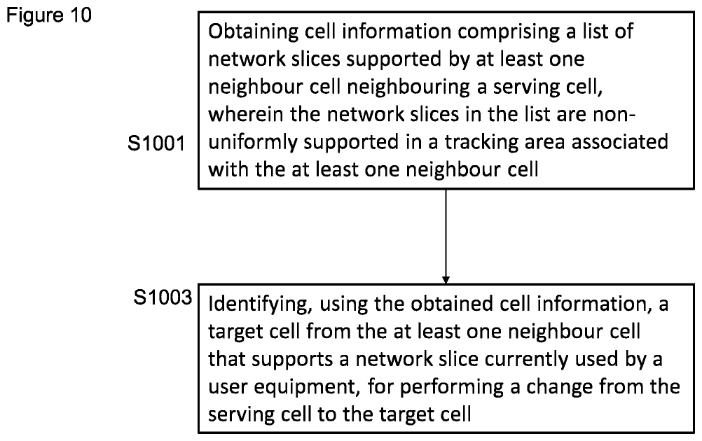

FIG. 10 shows an example method flow performed by an apparatus. The apparatus may be for a network access node. A network access node may be for example, a base station (gNB), or a near real-time radio intelligent controller (near-RT RIC). The gNB may provide a serving cell.

In S1001, the method comprises obtaining cell information comprising a list of network slices supported by at least one neighbour cell neighbouring a serving cell, wherein the network slices in the list are non-uniformly supported in a tracking area associated with the at least one neighbour cell.

In S1003, the method comprises identifying, using the obtained cell information, a target cell from the at least one neighbour cell that supports a network slice currently used by a user equipment, for performing a change from the serving cell to the target cell.

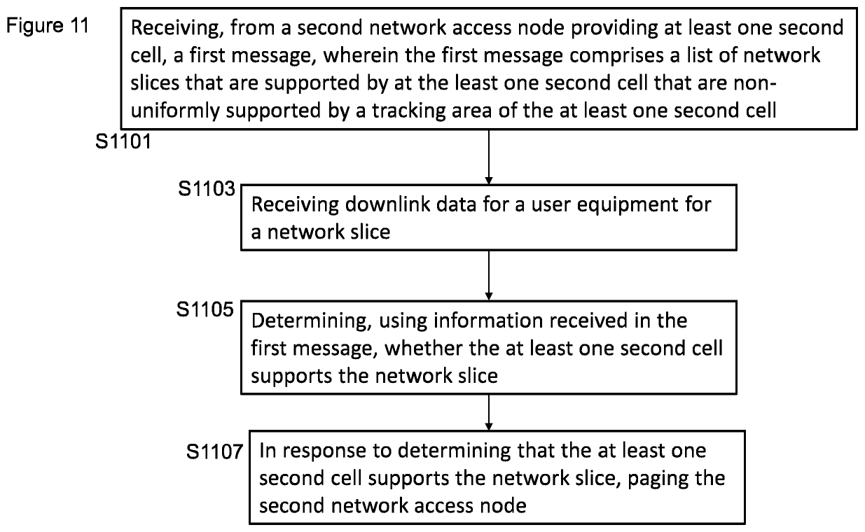

FIG. 11 shows an example method flow performed by an apparatus. The apparatus may be for a first network access node. A network access node may be for example, a base station (gNB), or a near-RT RIC.

In S1101, the method comprises receiving, from a second network access node providing at least one second cell, a first message, wherein the first message comprises a list of network slices that are supported by at the least one second cell that are non-uniformly supported by a tracking area of the at least one second cell.

In S1103, the method comprises receiving downlink data for a user equipment for a network slice.

In S1105, the method comprises determining, using information received in the first message, whether the at least one second cell supports the network slice.

In S1107, the method comprises in response to determining that the at least one second cell supports the network slice, paging the second network access node

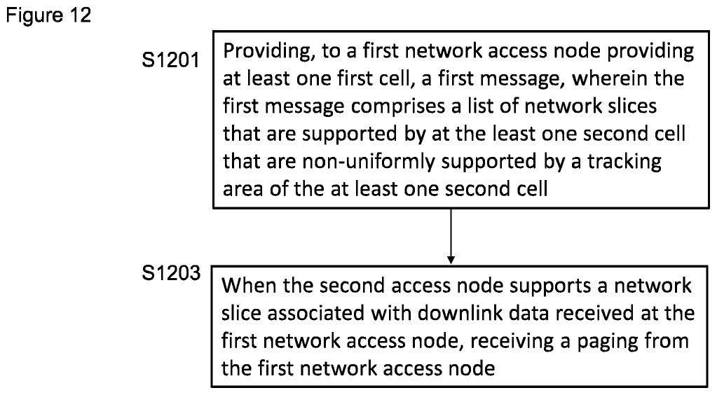

FIG. 12 shows an example method flow performed by an apparatus. The apparatus may be for a second network access node. A network access node may be for example, a base station (gNB).

In S1201, the method comprises providing, to a first network access node providing at least one first cell, a first message, wherein the first message comprises a list of network slices that are supported by at the least one second cell that are non-uniformly supported by a tracking area of the at least one second cell.

In S1203, the method comprises, when the second access node supports a network slice associated with downlink data received at the first network access node, receiving a paging from the first network access node.

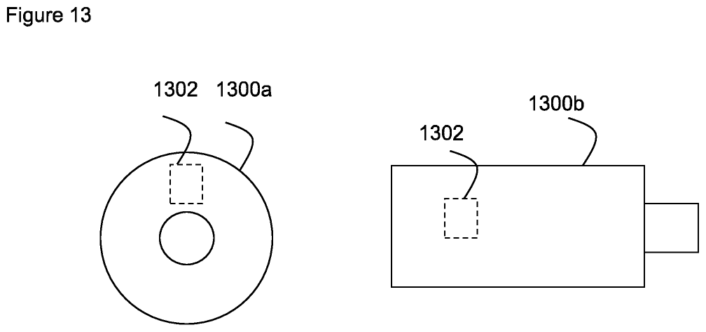

FIG. 13 shows a schematic representation of non-volatile memory media 1300a (e.g. computer disc (CD) or digital versatile disc (DVD)) and 1300b (e.g. universal serial bus (USB) memory stick) storing instructions and/or parameters 1302 which when executed by a processor allow the processor to perform one or more of the steps of the methods of FIG. 10, FIG. 11, or FIG. 12.

In should be understood that in the above signalling diagrams of FIGS. 6 to 9, there may be variations of the steps that take place. In some examples, some of the steps shown may be omitted. In some examples, some of steps may take place in a different order than shown in the Figures.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus for a first network access node, the apparatus comprising:
one or more processors, and
memory storing instructions that, when executed by the one or more processors, cause the apparatus to perform:
obtaining cell information comprising a list of network slices supported by at least one neighbour cell neighbouring a serving cell, wherein the network slices in the list are not available in all cells in a tracking area associated with the at least one neighbour cell; and
identifying, using the obtained cell information, a target cell from the at least one neighbour cell that supports a network slice currently used by a user equipment, for performing a change from the serving cell to the target cell.

2. An apparatus according to claim 1, wherein the cell information is obtained from a network management function of the first network access node.

3. An apparatus according to claim 1, wherein the apparatus is caused to perform:
receiving, from a second network access node serving the at least one neighbour cell, the cell information in a first message;
wherein the apparatus is caused to perform:
providing, to the second network access node, a request message identifying the target cell for a handover of the user equipment.

4. (canceled)

5. An apparatus according to claim 1, wherein the change from the serving cell to the target cell is performed by triggering a redirection procedure towards the user equipment.

6. The apparatus according to claim 1, wherein the network slice is being used in a protocol data unit session between the first network access node and the user equipment.

7. The apparatus according to claim 3, wherein the first message comprises an indication of the tracking area that the at least one cell is comprised in.

8. The apparatus according to claim 3, wherein the apparatus is caused to perform:
receiving, from a third network access node serving at least one further neighbour cell, further cell information in a second message, wherein the further cell information comprises a list of network slices that are not available in all the at least one further neighbour cell;
wherein the apparatus is further caused to perform:
determining, using the cell information and further cell information, whether the at least one neighbour cell and/or the at least one further neighbour cell supports the network slice:
wherein the apparatus is further caused to perform:
selecting, between the at least one neighbour cell and the at least one further neighbour cell, a cell for the handover of the user equipment based on the determination; and
providing the request message for handover to the network access node serving the selected cell.
wherein the apparatus is further caused to perform:
selecting, between the at least one neighbour cell and the at least one further neighbour cell, a cell for the handover of the user equipment based on the determination; and
providing the request message for handover to the network access node serving the selected cell;
wherein at least one of:
the second network access node serves a plurality of cells, the cell information comprising: per cell of the plurality of cells, a list of network slices that are supported by the respective cell, and not available in all cells in a tracking area of the respective cell; and
the third network access node serves a plurality of cells, the further cell information comprising: per cell of the plurality of cells, a list of network slices supported by the respective cell, and non-uniformly supported in a tracking area of the respective cell.

9-12. (canceled)

13. The apparatus according to claim 1, wherein the cell information comprises cell group mapping information for the tracking area of the at least one neighbour cell,
wherein the cell group mapping information maps the at least one neighbour cell to at least one group, the at least one group representing a list of slices that are non-uniformly supported in the tracking area of the respective cell.

14. The apparatus according to claim 13, wherein the apparatus is caused to perform:
receiving group mapping information for a tracking area of the at least one cell,
wherein the group mapping information maps the respective tracking area to the at least one group, the at least one group comprising a list of network slices that are non-uniformly supported in the tracking area.

15-21. (canceled)

22. An apparatus for a first network access node, the first network access node serving at least one first cell, the apparatus comprising:
one or more processors, and
memory storing instructions that, when executed by the one or more processors, cause the apparatus to perform:
receiving, from a second network access node serving at least one second cell, a first message, wherein the first message comprises a list of network slices that are supported by at the least one second cell and are not available in all cells in a tracking area of the at least one second cell;
receiving downlink data for a user equipment for a network slice;
determining, using information received in the first message, whether the at least one second cell supports the network slice; and
in response to determining that the at least one second cell supports the network slice, paging the second network access node.

23. An apparatus according to claim 22, wherein the paging comprises an indication of the network slice.

24. The apparatus according to claim 22, wherein apparatus is caused to perform:
providing, to a second network access node, a second message, wherein the second message comprises a list of network slices that are non-uniformly supported by the at least one first cell in a tracking area of the at least one first cell.

25. The apparatus according to claim 22, wherein the apparatus is caused to perform:
determining whether the at least one first cell supports the network slice; and
in response to determining that the at least one first cell supports the network slice, paging the user equipment from the at least one first cell.

26. The apparatus according to claim 22, wherein the first and second network access nodes are both part of a radio access network based notification area of a user equipment in radio resource control inactive state.

27. The apparatus according to claim 22, wherein the apparatus is caused to perform:
configuring a radio access network paging area, in the paging to second network node, to include cells that support the network slice, based on the determining whether the at least one second cell supports the network slice.

28. The apparatus according to claim 22, wherein the apparatus is caused to perform:
configuring the radio access network based notification area of the user equipment based on whether the at least one first cell of the first network access node and the at least one second cells of the second network access node supports the network slice, before moving the user equipment to radio resource control inactive state or during an radio access network based notification area update procedure.

29. The apparatus according to claim 22, wherein: the first message comprises cell group mapping information for the tracking area of the at least one second cell,
wherein the cell group mapping information maps the at least one second cell to at least one group, the at least one group representing a list of slices that are not available in all cells in the tracking area of the respective cell;
wherein the apparatus is caused to perform:
receiving group mapping information for the tracking area of the at least one second cell,
wherein the group mapping information maps the respective tracking area to the at least one group, the at least one group comprising a list of network slices that are not available in all cells in the tracking area.

30. (canceled)

31. The apparatus according claim 24, wherein the second message comprises cell group mapping information for a tracking area of the at least one first cell,
wherein the cell group mapping information maps the at least one first cell to at least one group, the at least one group representing a list of slices that are not available in all cells in the tracking area of the respective cell;
wherein the apparatus is caused to perform:
receiving group mapping information for the tracking area of the at least one first cell,
wherein the group mapping information maps the respective tracking area to the at least one group, the at least one group comprising a list of network slices that are not available in all cells in the tracking area.

32. (canceled)

33. The apparatus according to claim 22, wherein, when the second network access node serves at least two second cells, receiving, from the second network access node, the first message comprising: per cell of the at least two cells, a list of network slices that are non-uniformly supported by the cell in a tracking area of the cell;
wherein the apparatus is caused to perform:
determining, using information received in the first message, whether the at least two second cells support the network slice; and
in response to determining that one of the at least two second cells supports the network slice, paging the second network access node, wherein the paging comprises an indication of the network slice.

34-37. (canceled)

38. An apparatus for a second network access node, the second network access node serving at least one second cell, the apparatus comprising:
one or more processors, and
memory storing instructions that, when executed by the one or more processors, cause the apparatus to perform:
providing, to a first network access node serving at least one first cell, a first message, wherein the first message comprises a list of network slices that are supported by at the least one second cell that are not available in a tracking area of the at least one second cell; and
when the second access node supports a network slice associated with downlink data received at the first network access node, receiving a paging from the first network access node.

39-42. (canceled)
